(19) United States
(12) Patent Application Publication
(10) Pub. No.: US 2014/0274653 A1
(43) Pub. Date: Sep. 18, 2014

(54) PLASMA EROSION RESISTED TRANSPARENT Mg-Al-Y-Si-O

(71) Applicant: Applied Materials, Inc., Santa Clara, CA (US)

(72) Inventors: Ren-Guan DUAN, Fremont, CA (US); Juan Carlos ROCHA- ALVAREZ, San Carlos, CA (US)

(21) Appl. No.: 14/174,529

(22) Filed: Feb. 6, 2014

Related U.S. Application Data
(60) Provisional application No. 61/782,279, filed on Mar. 14, 2013.

(51) Int. Cl. C03C 3/095

(52) U.S. Cl. CPC C03C 3/095
USPC 501/64; 65/17.3

(57) ABSTRACT

Embodiments of the invention generally relate to a transparent material having an increased resistance to plasma erosion. The material is formed from yttrium oxide (Y₂0₃) at a starting powder composition ranging from about 5 weight percent (wt %) to about 40 weight percent; aluminum oxide (Al₂0₃) at a starting powder composition ranging from about 5 weight percent to about 30 weight percent; silicon dioxide (SiO₂) at a starting powder composition ranging from about 10 weight percent to about 80 weight percent; and magnesium oxide (MgO) at a starting powder composition ranging from about 1 weight percent to about 20 weight percent. The material may be a glass or glass-ceramic.

### CROSS-REFERENCE TO RELATED APPLICATIONS

This application claims benefit of U.S. Provisional Patent Application Ser. No. 61/782,279, filed Mar. 14, 2013, which is herein incorporated by reference.

### BACKGROUND OF THE INVENTION

1. Field of the Invention

Embodiments of the present invention generally relate to materials and coatings, and more specifically, to transparent materials resistant to corrosive plasmas of the kind used in the etching of semiconductor substrates.

2. Description of the Related Art

In ultraviolet (UV) process chambers, UV light is radiated from a UV source to a substrate located within the process chamber. A window and a showerhead are generally disposed within the UV light transmission path, and thus, the window and showerhead generally should have a UV transmittance of greater than about 60 percent at 254 nm. Additionally, it is desirable that the transmittance is substantially constant from process cycle to process cycle.

Quartz windows and showerheads have been used previously in UV process chambers. While the quartz satisfies the UV transmittance requirement initially, quartz erodes quickly in the presence of cleaning plasmas, such as NF₃ plasma. The increased surface roughness of the quartz caused by the erosion significantly decreases the UV transmittance of the quartz. Thus, chamber performance is negatively influenced, and component lifetime is decreased.

Therefore, there is a need for a need for chamber components made of a material having increased erosion resistance.

### SUMMARY OF THE INVENTION

Embodiments of the invention generally relate to a transparent material having an increased resistance to plasma erosion. The material is formed from yttrium oxide (Y₂0₃) at a starting powder composition ranging from about 5 weight percent (wt %) to about 40 weight percent; aluminum oxide (Al₂0₃) at a starting powder composition ranging from about 5 weight percent to about 30 weight percent; silicon dioxide (SiO₂) at a starting powder composition ranging from about 10 weight percent to about 80 weight percent; and magnesium oxide (MgO) at a starting powder composition ranging from about 1 weight percent to about 20 weight percent. The material may be a glass or glass-ceramic.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a normalized graph illustrating the erosion rates of compounds relative to the material of the present invention.

FIG. 2 is a graph illustrating the percent transmittance of the material of the present invention and of quartz before and after exposure to NF₃ plasma.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the invention generally relate to a transparent material having an increased resistance to plasma erosion. The material is formed from yttrium oxide (Y₂0₃) at a starting powder composition ranging from about 5 weight percent (wt %) to about 40 weight percent; aluminum oxide (Al₂0₃) at a starting powder composition ranging from about 5 weight percent to about 30 weight percent; silicon dioxide (SiO₂) at a starting powder composition ranging from about 10 weight percent to about 80 weight percent; and magnesium oxide (MgO) at a starting powder composition ranging from about 1 weight percent to about 20 weight percent. The material may be a glass or glass-ceramic. In one example, the material is amorphous.

In some embodiments, the starting material compositions listed above may be used to form a glass or glass-ceramic coating over the surface of a variety of metal and ceramic substrates, including, but not limited to, aluminum, aluminum alloy, stainless steel, alumina, aluminum nitride and quartz. The glass or glass-ceramic coating may be formed using a technique such as plasma spraying. In other embodiments, the substrate themselves may be formed the material compositions referred to above. Exemplary applications for materials described herein include, but are not limited to, components used internal to a plasma processing chamber, such as a lid, lid-liner, nozzle, gas distribution plate or shower head, electrostatic chuck components, shadow frame, substrate holding frame, processing kit, and chamber liner.

A glass may be formed by mixing the above composition, subjecting the composition to high temperature melting, and quenching the melted composition. Also, a glass may be formed by mixing the above composition, subjecting the composition to high temperature melting, and cooling the melted composition together with a molder/holder and then removing the molder/holder. A glass-ceramic material may also be formed from the above composition. To form a glass-ceramic, a glass is first formed and then is thermally treated at a temperature lower than the melting point of the material. Alternatively, a glass-ceramic may be formed by first forming a glass and then crushing the glass into small pieces that are loaded into one molder. The crushed glass is then thermally treated at temperature lower than the melting point of the crushed glass.

FIG. 1 is a normalized graph illustrating the erosion rates of compounds relative to the material of the present invention. The material of the present invention will herein be referred to as “Material 1”, and it is to be understood that the term “Material 1” refers to any and all materials having a composition of yttrium oxide (Y₂0₃) at a starting powder composition ranging from about 5 weight percent (wt %) to about 40 weight percent; aluminum oxide (Al₂0₃) at a starting powder composition ranging from about 5 weight percent to about 30 weight percent; silicon dioxide (SiO₂) at a starting powder composition ranging from about 10 weight percent to about 80 weight percent; and magnesium oxide (MgO) at a starting powder composition ranging from about 1 weight percent to about 20 weight percent.

Four samples (a first sample of Y₂O₃, a second sample of Material 1, a third sample of Al₂O₃, and a fourth sample of quartz) were exposed for five hours to 500 sccm of NF₃ gas ignited into a plasma at conditions of 400 degrees Celsius and 2.8 Torr. The erosion rates were normalized using an erosion rate of Material 1 equal to one. As illustrated in FIG. 1, the erosion rate of pure quartz when exposed to NF₃ plasma is about 20 times the erosion rate of Material 1. The erosion rate of pure Al2O3 is 3.33 times the erosion rate of Material 1. The erosion rate of pure Y₂O₃ is 0.67 times the erosion rate of Material 1. However, it is to be noted that pure crystalline yttrium oxide, while offering good corrosion resistance to various etchant plasmas, does not offer any application as a window or showerhead in a UV chamber. While Y₂O₃ can be transparent, the size or thickness of transparent Y₂O₃ is limited, and thus has limited application. Moreover, transparent Y₂O₃ is relatively expensive. Therefore, Y₂O₃ can be undesirable for use in processing chambers in some instances.

FIG. 2 is a graph illustrating the percent transmittance of the material of the present invention (e.g., Material 1) and of quartz before and after exposure to NF₃ plasma. The transmittance of a 1 millimeter (mm) thick quartz substrate and a 1 mm thick Material 1 substrate was measure before and after exposure to an NF₃ plasma under the same conditions described above with respect to FIG. 1. As illustrated, the transmittance of quartz decreases significantly after exposure to a halogen-containing plasma. Material 1, however, exhibits no such decrease, and in some embodiments, may exhibit some increase. Thus, material 1 facilitates nearly constant levels of transmittance, even after exposure to halogen-containing plasmas.

In one example, Material 1 is a transparent glass material formed from 29.0 weight percent Y₂O₃ powder (10.3 molar percent); 19.3 weight percent Al₂O₃ powder (15.1 molar percent); 42.6 weight percent SiO₂ (56.8 molar percent); and 9.1 weight percent MgO (18.0 molar percent). The transmittance of light at a wavelength of 250 nm through a one millimeter thick sample of Material one is 78 percent. Table 1 illustrates the properties of this specific composition of Material 1 relative to the properties of pure Y₂O₃ and quartz.

TABLE 1

| Material Property | Y₂O₃ | Quartz | Material 1 |
|---|---|---|---|
| Density (g/cm³) | 4.90 | 2.20 | 3.10 |
| Flexural Strength (MPa) | 110 | 35 | 104 |
| Vickers Hardness (5 Kgf) (GPa) | 6.0 | 4.6 | 7.1 |
| Fracture Toughness (MPa · m^{1/2}) | 1.2 | 0.8 | 1.2 |
| Young's Modulus (GPa) | 160 | 72 | 113 |
| Thermal Expansion × 10⁻⁶/K | 7.8 | 0.5 | 6.8 |
| (20~900° C.) | | | |
| Thermal Conductivity (W/mK) | 14 | 1.5 | 1.3 |
| Dielectric Constant (20° C., 13.56 | 12.5 | 3.6 | 8.2 |
| MHz) | | | |
| Dielectric Loss Tangent × 10⁻⁴ | <10 | 2 | 30 |
| (20° C., 13.56 MHz) | | | |
| Dielectric Strength (kV/mm) | 10 | 13 | 12 |
| Volume Resistivity (at 23° C.) | >10¹⁵ | >10¹⁵ | >10¹⁵ |
| (Ohm-cm) | | | |

In comparison to quartz, Material 1 exhibits higher mechanical and thermal expansion properties, while having comparable thermal conductivity. In comparison to Y₂O₃, Material 1 exhibits a higher Vickers hardness, lower thermal conductivity, a lower dielectric constant, and comparable fracture toughness. It is to be noted that while the above transmittance value is provided for a specific composition of Material 1, the transmittance value is generally indicative of the entire range of composition for Material 1 provided herein.

Benefits of the invention include glass or glass-ceramic materials having decreased erosion rates and increased transmittance. The decrease in erosion rate extends the lifetime of a component in a process chamber which includes the glass or glass-ceramic material of the present invention therein. Thus, the replacement frequency of components is such an apparatus is reduced, thereby reducing apparatus down time. Moreover, the particle level generated during a plasma process is reduced, enabling a device fabrication with ever shrinking geometry and reduced overall cost.

While the foregoing is directed to embodiments of the present invention, other and further embodiments of the invention may be devised without departing from the basic scope thereof, and the scope thereof is determined by the claims that follow.

We claim:

1. A transparent article which is resistant to erosion by halogen-containing plasmas, the article formed from yttrium oxide within a range from about 5 weight percent (wt %) to about 40 weight percent; aluminum oxide within a range from about 5 weight percent to about 30 weight percent; silicon dioxide within a range ranging from about 10 weight percent to about 80 weight percent; and magnesium oxide within a range from about 1 weight percent to about 20 weight percent.

2. The transparent article of claim 1, wherein a 1 millimeter thick section of the transparent article has a transmittance of light at a wavelength of 250 nm of about 78 percent.

3. The transparent article of claim 2, comprising a density of about 3.10 grams per cubic centimeter.

4. The transparent article of claim 3, comprising a flexural strength of about 104 MPA.

5. The transparent article of claim 4, comprising a Young's modulus of about 113 GPa.

6. The transparent article of claim 1, comprising a thermal conductivity of about 1.3 W/mK.

7. The transparent article of claim 1, comprising a density of about 3.10 grams per cubic centimeter, a flexural strength of about 104 MPA, and a Young's modulus of about 113 GPa.

8. The transparent article of claim 1, comprising a flexural strength of about 104 MPA, a Young's modulus of about 113 GPa, and a thermal conductivity of about 1.3 W/mK.

9. The transparent article of claim 8, wherein a 1 millimeter thick section of the transparent article has a transmittance of light at a wavelength of 250 nm of about 78 percent.

10. A method of processing a material, comprising:
combining:
yttrium oxide within a range from about 5 weight percent (wt %) to about 40 weight percent;
aluminum oxide within a range from about 5 weight percent to about 30 weight percent;
silicon dioxide within a range ranging from about 10 weight percent to about 80 weight percent; and
magnesium oxide within a range from about 1 weight percent to about 20 weight percent; and
heating the combined materials.

11. The method of claim 10, wherein the combined materials are heated to a temperature above the melting point of yttrium oxide, aluminum oxide, silicon dioxide, and magnesium oxide.

12. The method of claim 11, further comprising:
allowing the heated combination of materials to cool; then
crushing the cooled combination of materials;
loading the crushed materials into a mold; and then
thermally treating the crushed materials at a temperature lower than the melting of yttrium oxide, aluminum oxide, silicon dioxide, and magnesium oxide.

13. The method of claim 11, further comprising disposing the combined material in a mold.

14. The method of claim 11, further comprising quenching the heated combination of materials.

15. The method of claim 10, further comprising applying the combined materials to the surface of a semiconductor processing showerhead, electrostatic chuck, or liner.
